(19) United States
(12) Patent Application Publication
(10) Pub. No.: US 2005/0010932 A1
(43) Pub. Date: Jan. 13, 2005

(54) Information providing system

(75) Inventors: Atsushi Kohno, Tokyo (JP); Masaharu Umezu, Tokyo (JP); Mitsuo Shimotani, Tokyo (JP); Kazuma Kaneko, Tokyo (JP); Fumitaka Satoh, Tokyo (JP); Yosuke Asai, Tokyo (JP); Harumi Minemura, Tokyo (JP); Akio Uekawa, Osaka (JP); Keiichiro Uekawa, Osaka (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI DENKI KABUSHIKI KAISHA

(21) Appl. No.: 10/885,751

(22) Filed: Jul. 8, 2004

(30) Foreign Application Priority Data
Jul. 11, 2003 (JP) 2003-196014

(51) Int. Cl. G06F 9/00

(52) U.S. Cl. 719/328

(57) ABSTRACT

In an information providing system, when a plurality of Java (registered trademark) applications (28 and 29) which can run simultaneously on an extended functional module (27) are installed into the extended functional module (27), application management modules (32 and 34) manage the operations of the plurality of Java applications (28 and 29), respectively. Thereby, the information providing system can make the plurality of Java applications (28 and 29) operate simultaneously without causing a resource conflict.

### BACKGROUND OF THE INVENTION

1. Field of the Invention

The present invention relates to an information providing system that provides various types of information services.

2. Description of Related Art

A prior art information providing system includes a basic functional module such as a navigation service, and an extended functional module such as a Java application which runs on the Java (a registered trademark) virtual machine (referred to as JavaVM (Virtual Machine)), and each of the basic functional module and the extended functional module of the information providing system is provided with an interface for communicating with the party on the other end, so that the basic functional module and the extended functional module can work in cooperation with each other (for example, see patent reference 1).

Patent reference 1: Japanese patent application publication No. 2002-318702 (paragraph number [0008] and FIG. 2)

Since the prior art information providing system is constructed as mentioned above, it can make the basic functional module and a Java application work in cooperation with each other. A problem with the prior art information providing system is however that since it has no module for managing the operations of Java applications, when a plurality of Java applications which can run simultaneously on the JavaVM are installed into the JavaVM, the plurality of Java applications may conflict with one another for the resource of the system.

### SUMMARY OF THE INVENTION

The present invention is made in order to solve the above-mentioned problem, and it is therefore an object of the present invention to provide an information providing system which can make a plurality of service applications operate simultaneously without causing a resource conflict.

In accordance with the present invention, there is provided an information providing system including an application management module for managing the operations of a plurality of service applications which run simultaneously on an extended functional module.

As mentioned above, in accordance with the present invention, the application management module of the information providing system manages the operations of a plurality of service applications which run simultaneously on the extended functional module. Therefore, the present invention offers an advantage of being able to make a plurality of service applications operate simultaneously without causing a resource conflict in the information providing system.

Further objects and advantages of the present invention will be apparent from the following description of the preferred embodiments of the invention as illustrated in the accompanying drawings.

### BRIEF DESCRIPTION OF THE DRAWINGS

FIG. 1 is a block diagram showing the hardware configuration of an information providing system in accordance with embodiment 1 of the present invention;

FIG. 2 is a block diagram showing the software configuration of the information providing system in accordance with embodiment 1 of the present invention;

FIG. 3 is a block diagram showing the software configuration of an information providing system in accordance with embodiment 2 of the present invention;

FIG. 4 is a block diagram showing the software configuration of the information providing system in accordance with embodiment 2 of the present invention;

FIG. 5 is a flow chart showing a process of adding a Java application;

FIG. 6 is an explanatory drawing showing an example of an application management table;

FIG. 7 is an explanatory drawing showing an example of an additional application list;

FIG. 8 is a flow chart showing a process of deleting a Java application;

FIG. 9 is an explanatory drawing showing an example of a menu screen;

FIG. 10 is a flow chart showing a process of starting up a Java application;

FIG. 11 is a flow chart showing a process of managing input to an application management module;

FIG. 12 is a flow chart showing a process of managing input to an application management module;

FIG. 13 is an explanatory drawing showing an example of a split screen with part produced by a basic functional module and part produced by a Java application within an extended functional module;

FIG. 14 is an explanatory drawing showing an example of a split screen with part produced by the basic functional module, part produced by a Java application within the extended functional module, and part produced by another Java application within the extended functional module;

FIG. 15 is a flow chart showing a process of managing output from an application management module;

FIG. 16 is a flow chart showing a process of managing output from an application management module;

FIG. 17 is an explanatory drawing showing information about management of screen display areas displayed on a split screen;

FIG. 18 is an explanatory drawing showing information about management of screen display areas displayed on a split screen by Java applications;

FIG. 19 is a flow chart showing a process of managing input to an application management module;

FIG. 20 is a flow chart showing a process of managing input to an application management module;

FIG. 21 is a block diagram showing the software configuration of an information providing system in accordance with embodiment 3 of the present invention;

FIG. 22 is a block diagram showing the software configuration of an information providing system in accordance with embodiment 4 of the present invention;

FIG. 23A is a flow chart showing a process of adding a Java application startup command;

FIG. 23B is a table showing an application startup command management table;

FIG. 24 is a flow chart showing a process of recognizing a voice command;

FIG. 25 is a flow chart showing a process of terminating an application when there is not enough free space of memory;

FIG. 26 is a flow chart showing a automatic updating process performed by the JavaVM; and

FIG. 27 is a flow chart showing a process of automatically updating an application management module.

### DETAILED DESCRIPTION OF THE PREFERRED EMBODIMENTS

The preferred embodiments of the present invention will be now described with reference to the accompanying drawings.

Embodiment 1.

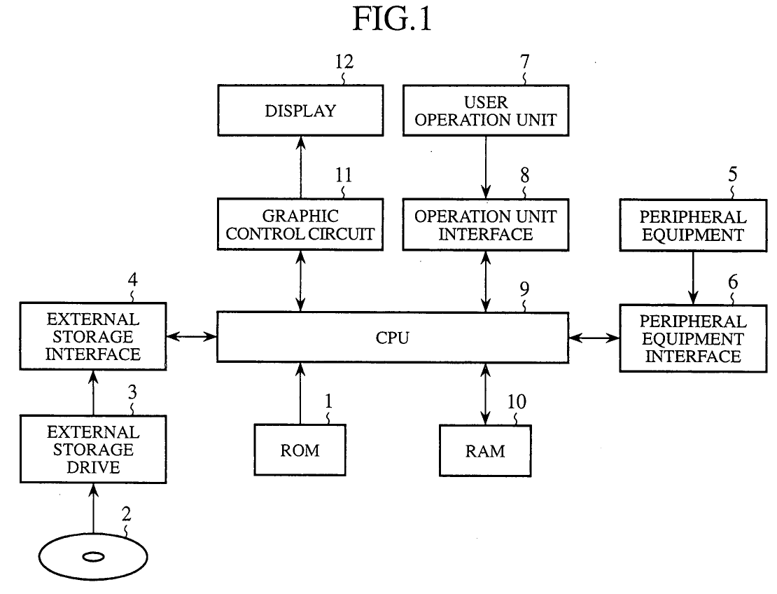

FIG. 1 is a block diagram showing the hardware configuration of an information providing system in accordance with embodiment 1 of the present invention. In the figure, a ROM 1 stores a program which implements a basic functional module and a program which implements an extended functional module. An external memory medium 2 consists of a DVD-ROM, a CD-ROM, or a hard disk, for example. The external memory medium 2 stores a map database and extended vehicle-mounted service applications. The external storage drive 3 can read map data from the external memory medium 2 so as to output the map data to a CPU 9 by way of an external storage I/F 4. Peripheral equipment 5 can be a GPS receiver, a gyroscope, a vehicle speed pulse sensor, a speaker, or a mobile phone. For example, the peripheral equipment 5 outputs a GPS signal to the CPU 9 by way of a peripheral equipment I/F 6.

A user operation unit 7 can be a remote control unit, various switches, or a touch panel. For example, a user operation unit 7 outputs an operation signal to the CPU 9 by way of an operation unit I/F 8. The CPU 9 executes the program which implements the basic functional module and a program which implements the extended functional module according to the operation signal delivered thereto from the user operation unit 7 while referring to the map data and the GPS signal. Data and so on which the CPU 9 uses when executing a program are temporarily stored in a RAM 10. A graphic control circuit 11 draws images on a display 12 according to a drawing command delivered thereto from the CPU 9.

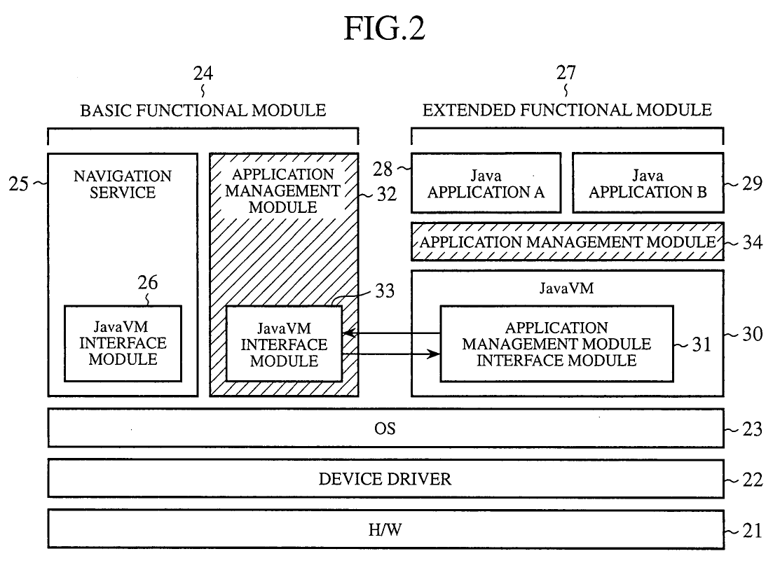

FIG. 2 is a block diagram showing the software configuration of the information providing system in accordance with embodiment 1 of the present invention. In the figure, an H/W 21 corresponds to the hardware of the information providing system of FIG. 1. A device driver 22 controls each of the processing units (for example, the CPU 9 and the external storage drive 3) of the H/W 21. While an OS 23 controls each of the processing units of the H/W 21 by using the device driver 22, the OS 23 offers an operating environment in which the basic functional module 24 and the extended functional module 27 work so as to execute programs. The basic functional module 24 consists of a navigation service 25 which offers the current position of the vehicle and information about facilities as a fundamental vehicle-mounted information service. A Java module 26 carries out communications with an application management module interface module 31 included in a Java virtual machine (or JavaVM) 30 when the navigation service 25 works hand-in-hand with Java applications 28 and 29.

The extended functional module 27 is constructed of the JavaVM 30 that starts up the Java applications 28 and 29 in cooperation with the basic functional module 24 when the Java applications 28 and 29 which are service applications programmed in Java language are installed thereinto. The JavaVM 30 complies with CDC (Connected Device Configuration) and FP (Foundation Profile) defined by Sun Microsystems Inc. The JavaVM 30 can be implemented by the Java applications 28 and 29 operating as threads within processes of the JavaVM 30. For example, the Java application 28 is a service application that performs a weather forecast, and the Java application 29 is a service application that reads one's fortune.

An application management module 32 is disposed as a submodule of the basic functional module 24, and is provided with a JavaVM I/F module 33 that carries out communications with the application management module interface module 31 disposed within the JavaVM 30. An application management module 34 is disposed as one Java application that is installed into the extended functional module 27. The application management modules 32 and 34 which are respectively disposed in the basic functional module 24 and the extended functional module 27 manage the operations of the Java applications 28 and 29 in cooperation with each other.

Each of the application management modules 32 and 34 has the following management functions.
(1) Registration (or addition)/deletion/updating of a Java application
(2) Startup/stop/status management of a Java application
(3) Management of input to a Java application
(4) Management of screen display output from a Java application

Next, the operation of the information providing system in accordance with this embodiment of the present invention will be explained.

(1) Addition/Deletion/Updating of a Java Application

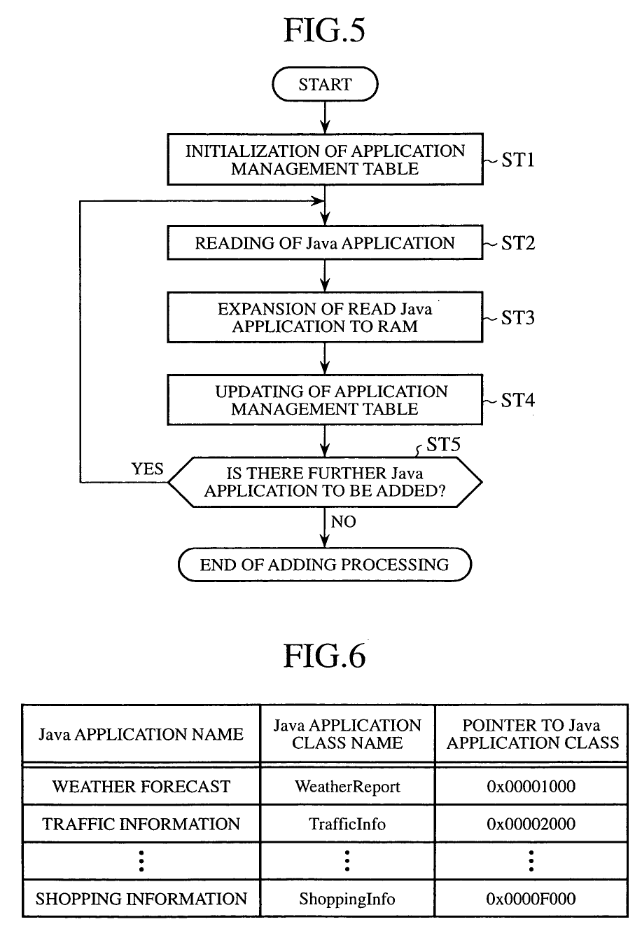

The application management module 34 disposed in the extended functional module 27 performs addition/deletion/updating of a Java application. FIG. 5 is a flow chart showing the process of adding a Java application. First, the application management module 34 initializes an application management table disposed therein (in step ST1). As shown in FIG. 6, the names of Java applications that are installed into the information providing system, the names of corresponding Java application classes, and the addresses of locations where the Java application classes are placed in the RAM 10 (i.e., pointers pointing the Java application classes, respectively) are described in the application management table. For the sake of simplicity, in accordance with this embodiment 1, a certain amount of memory is provided for each Java application class. As an alternative, an unfixed amount of memory can be provided for each Java application class.

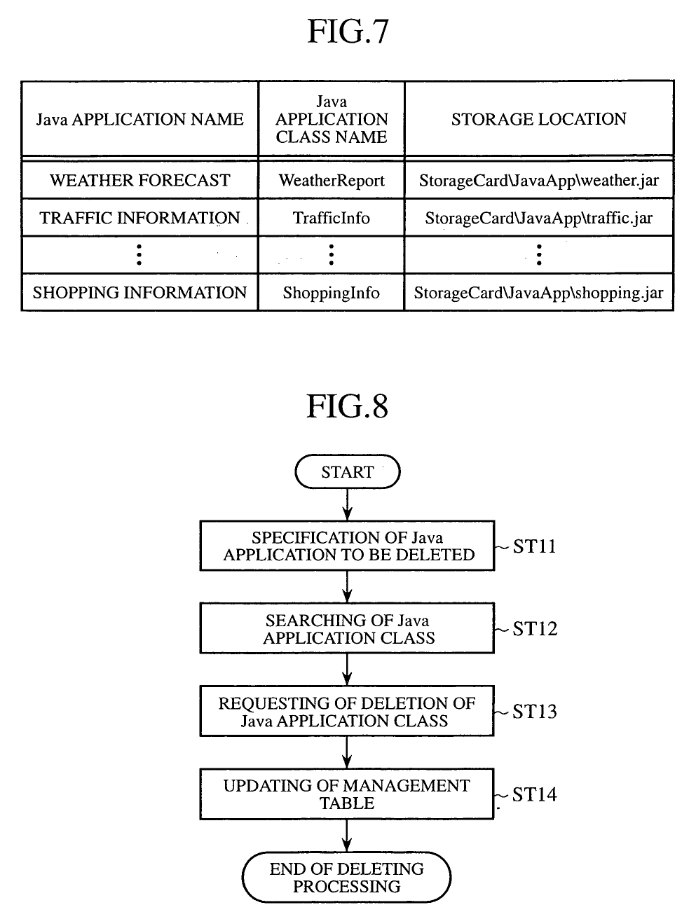

The application management module 34 then reads a Java application (i.e., a Java application class) listed in an additional application list (see FIG. 7) that is described in advance from the external memory medium 2 (in step ST2), and makes a request of the JavaVM 30 for placement of the read Java application in the RAM 10 on the H/W 21 (in step ST3). As a result, the JavaVM 30 places the Java application class in the RAM 10 on the H/W 21, and sends a RAM address (i.e., a pointer) of the Java application class back to the application management module 34. The additional application list is a table in which the names of Java applications to be added, the names of corresponding Java application classes, and directory names indicating the locations where the Java application classes are respectively stored are described, as shown in FIG. 7, and the application management module 34 can grasp a location where each Java application to be added is stored by referring to the additional application list.

When receiving the RAM address (i.e., the pointer) of a Java application class to be added from the JavaVM 30, the application management module 34 updates the application management table by additionally writing the application name of the Java application, the name of the Java application class, and the RAM address (i.e., the pointer) of the Java application class in the application management table (in step ST4). The method of updating the application management table can be implemented by serially adding those items to the last line of the application management table. The application management module 34 determines whether there is a further Java application which should be added with reference to the additional application list (in step ST5), and, when there is a further Java application which should be added, returns to the process of reading a Java application of step ST2 and the repeats the reading process, whereas the application management module 34 ends the additional processing when there is no Java application which should be added. As previously explained, any Java application to be added is listed in the additional application list described in advance. As an alternative, the application management module 34 can search through the external memory medium 2 for Java application classes to be added so as to create the additional application list dynamically, and can carry out the additional processing.

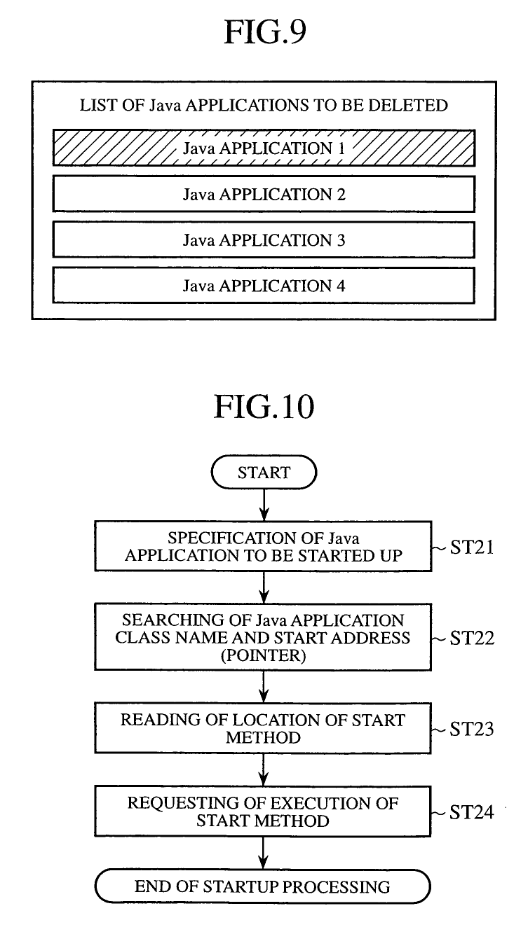

FIG. 8 is a flow chart showing a process of deleting a Java application. The application management module 34 displays a menu screen as shown in FIG. 9 on the display 12 in order to receive specification of a Java application to be deleted. The user using the information providing system can specify a Java application to be deleted from a list of Java applications currently displayed in the menu screen. For example, the user specifies a Java application to be deleted by using a touch panel which is the user operation unit 7 (in step ST11). In the example of FIG. 9, “Java application 1” is specified as the Java application to be deleted by the user. When identifying the Java application to be deleted according to the user's operation of the user operation unit 7, the application management module 34 searches through the application management table for the name of a Java application class name corresponding to the Java application to be deleted (i.e., the name of the Java application) (in step ST12), and them makes a request of the JavaVM 30 for deletion of the Java application class (in step ST13).

As a result, the JavaVM 30 deletes the corresponding line in which the Java application to be deleted is described from the application management table, carries out a process of upwardly shifting the lines located under the eliminated line, and ends the deleting processing (instep ST14). In accordance with this embodiment 1, the user specifies a Java application to be deleted, as previously mentioned. As an alternative, another Java application can specify a Java application to be deleted. The navigation service 25 of the basic functional module 24 can alternatively specify a Java application to be deleted. As the method of specifying a Java application to be deleted, there are a method of specifying the name of the Java application to be deleted, and a method of specifying the name of the corresponding Java application class.

The process of updating a Java application is carried out as follows. When a Java application to be updated is specified, as in the case where a Java application to be deleted is specified, the application management module 34 deletes the Java application to be updated in the same way that it deletes the Java application to be deleted in the Java application deleting mode. After that, the application management module 34 searches for a new version of the Java application to be updated from the external memory medium 2, and completes the updating processing by adding the new version of the Java application to be updated to the application management table according to the above-mentioned adding procedure. Instead of searching for the new version of the Java application to be updated from the external memory medium 2, the application management module 34 can use a mobile phone which is one peripheral equipment 5 so as to download the new version of the Java application to be updated from a server apparatus on the network or the like and to add the new version of the Java application to the information providing system. As an alternative, the application management module 34 can search through a ROM for the new version of the Java application to be updated recorded in the ROM and add the new version of the Java application to the information providing system.

(2) Startup/Stop/Status Management of a Java Application

The application management module 34 disposed in the extended functional module 27 can implement startup/stop/status management of each Java application by calling methods (also referred to as functions from here on) of each Java application. FIG. 10 is a flow chart showing a process of starting up a Java application. When a Java application to be started up is specified as in the case where a Java application to be deleted is specified (in step ST21), the application management module 34 searches through the application management table for both the name of a Java application class corresponding to the Java application to be started up, and a RAM address (i.e., a pointer) of the Java application class (in step ST22).

The application management module 34 then reads an offset from the starting address with respect to a RAM address where a start method of each Java application is located from Java class information described at the head of the Java application class (in step ST23), makes a request of the JavaVM 30 for execution of the Java program from the RAM address of the start method (in step ST24), and ends the process of starting up the Java application.

Instead of reading the RAM address of the start method from the Java application class information, the application management module 34 can locate the start method at an address having a certain fixed offset. Although the above-mentioned explanation is made as to the method of starting up a Java application, by calling a method of the Java application which is a service application, stop (definition: stop method) of the Java application and status management (definition: is Alive method) of the Java application can be implemented according to the same procedure. The is Alive method of a Java application sends information indicating whether or not the Java application is running normally back to the application management module 34.

(3) Management of Input to a Java Application

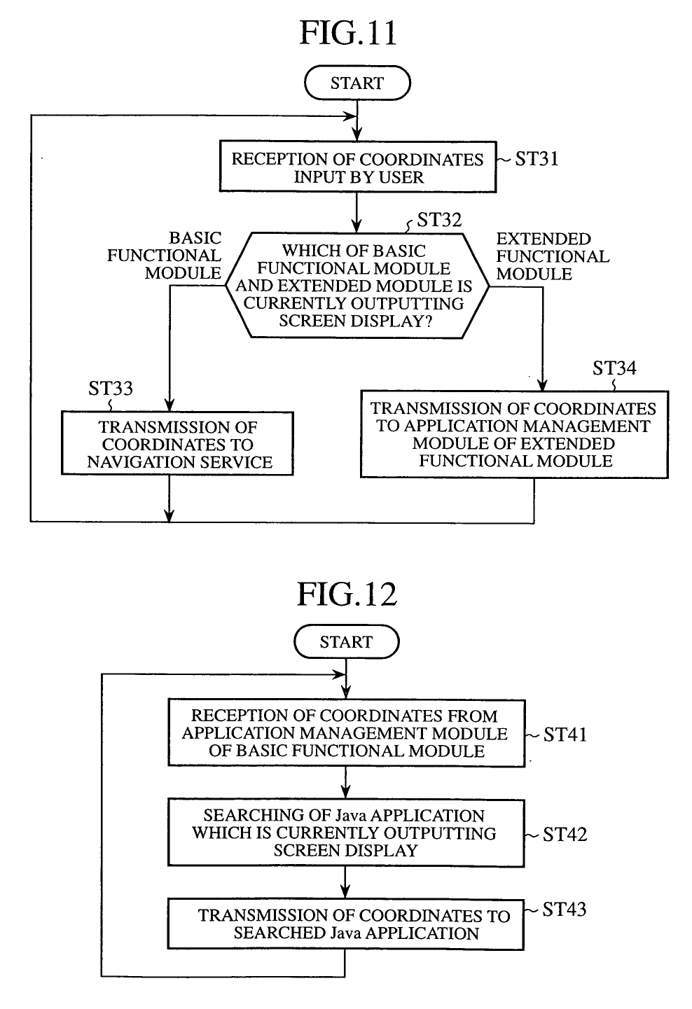

Since the user's input to the information providing system includes an input to the basic functional module 24, such as the navigation service 25, and an input to the extended functional module 27, such as an input to the Java application 28 or 29, the application management modules 32 and 34 perform input management processing in cooperation with each other. First, input management processing performed by the application management module 32 located in the basic functional module 24 will be explained. FIG. 11 is a flowchart showing the input management processing performed by the application management module 32. Assume that the user operation unit 7 shown in FIG. 1 is a touch panel and the operation unit I/F 8 delivers the coordinates of a location where the user touches the touch panel to the CPU 9 (since the touch panel operates in the same way that a touch panel disposed in a well-known car navigation equipped with a touch panel function does, the explanation of the operation of the touch panel will be omitted).

First, the application management module 32 receives the coordinates of a location where the user touches the touch panel, which the operation unit I/F 8 has delivered to the CPU 9, by way of the device driver 22 and the OS 23 (in step ST31). The application management module 32 then determines whether or not the module which is producing a screen display now is the basic functional module 24, such as the navigation service 25, or the extended functional module 27, such as the Java applications 28 and 29 (in step ST32). A procedure for managing output of a screen display will be mentioned later.

If the module which is producing a screen display now is the navigation service 25, the application management module 32 furnishes the received coordinates of a location where the user touches the touch panel to the navigation service 25 (in step ST33). On the other hand, if the module which is producing a screen display now is the extended functional module 27, such as the Java application 28 or 29, the application management module 32 transmits the received coordinates to the application management module 34 by using the JavaVM I/F module 33 and the application management module interface module 31 (in step ST34). After that, the application management module 32 returns to the process of receiving the coordinates of a location where the user touches the touch panel (in step ST31).

Next, the input management processing performed by the application management module 34 located in the extended functional module 27 will be explained. FIG. 12 is a flow chart showing the input management processing performed by the application management module 34. When receiving the coordinates transmitted thereto from the application management module 32 of the basic functional module 24 (in step ST41), the application management module 34 searches for the Java application which is currently producing and outputting a screen display (in step ST42). For example, if the Java application which is currently producing and outputting a screen display is the Java application 28, the application management module 34 delivers the received coordinates to the Java application 28 (in step ST43). The process of transmitting the coordinates of a location where the user touches the touch panel to the Java application 28 can be implemented by using an event processing by a Java program. After that, the application management module 34 returns to the process of receiving the coordinates transmitted thereto from the application management module 32 (in step ST41).

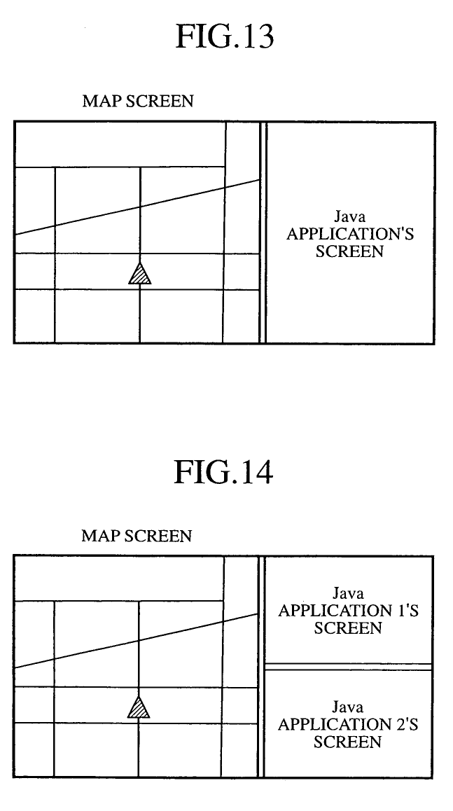

In the above-mentioned explanation, it is assumed that either the basic functional module 24 or the extended functional module 27 is currently producing and outputting a screen display. As an alternative, as shown in FIG. 13, both the navigation service 25 of the basic functional module 24 and the Java application 28 or the like of the extended functional module 27 can be simultaneously producing and outputting screen displays. A procedure for managing screen displays will be explained later. In this case, what is necessary is just to change the module to which the coordinates of a location where the user touches the touch panel is to be transmitted according to the coordinates. Similarly, a plurality of Java applications, not only a single Java application, which are located in the extended functional module 27, can be simultaneously producing and outputting screen displays (see FIG. 14).

Although the input coordinates of a location where the user touches the touch panel is given to the application management module 32 located in the basic functional module 24 first, as previously explained, it can be alternatively given to the application management module 34 located in the extended functional module 27 first.

Although a touch panel is adopted as the user operation unit 7, as previously explained, a joystick which is widely used as a user operation unit of prior art car navigation apparatus (the joystick can produce a screen display in which a module which is a target for display output is highlighted) can be adopted as the user operation unit 7 in the same way as the touch panel.

(4) Management of Screen Display Output from a Java Application

Since each of the basic functional module 24 and the extended functional module 27 performs a process of outputting a screen display from a service application, the application management modules 32 and 34 perform a process of managing output of a screen display from the service application in cooperation with each other, as in the case of performing the input management processing. Each of the basic functional module 24 and the extended functional module 27 can perform screen display output processing by controlling the graphic control circuit 11 of the H/W 21 by way of the OS 23 and the device driver 22.

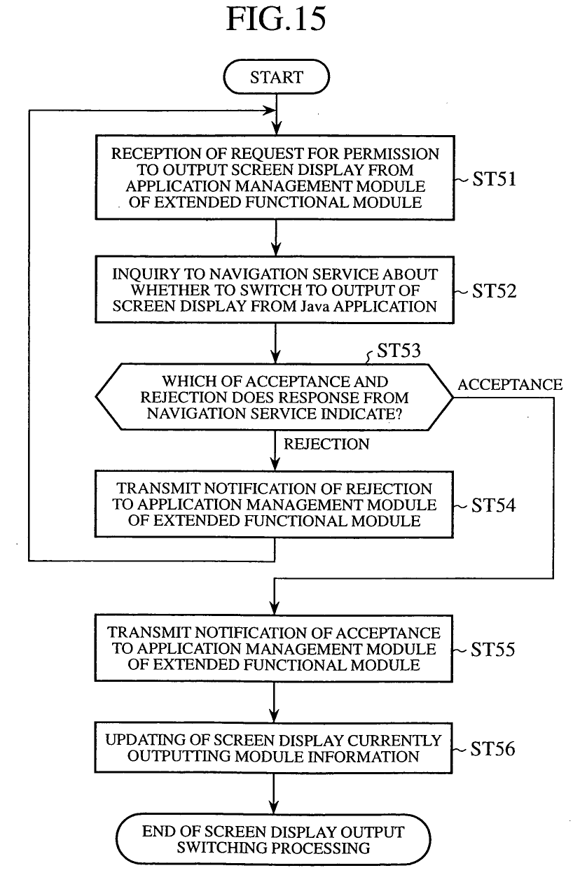

First, the screen display output management processing performed by the application management module 32 located in the basic functional module 24 will be explained. FIG. 15 is a flow chart showing the screen display output management processing performed by the application management module 32. The application management module 32 checks to see whether either the basic functional module 24, such as the navigation services 25, or the extended functional module 27, such as the Java application 28 or 29, is currently producing and outputting a screen display. The application management module 32 enables output of a screen display from the navigation device 25 of the basic functional module 24 by default (i.e., immediately after the information providing system is started up).

After that, when the JavaVM 30 of the extended functional module 27 receives a request for permission to produce and output a screen display from either of the Java applications 28 and 29, the application management module 34 of the extended functional module 27 makes a request of the application management module 32 of the basic functional module 24 for permission to produce and output a screen display. When receiving the request for permission to produce and output a screen display from the extended functional module 27 (in step ST51), the application management module 32 of the basic functional module 24 inquires of the navigation service 25 whether it can give permission to switch the source of the on-screen display to either of the Java applications 28 and 29 (in step ST52). When receiving a response indicating that the navigation service 25 does not accept the request for a change of the screen display output from the navigation service 25 (in step ST53), the application management module 32 of the basic functional module 24 transmits a notification of rejection of the request for switching of the source of the on-screen display to either of the Java applications 28 and 29 to the application management module 34 of the extended functional module 27 (in step ST54).

When receiving a response indicating that the navigation service 25 has accepted the request for switching of the source of the on-screen display to either of the Java applications 28 and 29 from the navigation service 25 (in step ST53), the application management module 32 of the basic functional module 24 transmits a notification that the request for switching of the source of the on-screen display has been accepted to the application management module 34 of the extended functional module 27 (in step ST55). After transmitting a notification of acceptance of the request for switching of the source of the on-screen display to either of the Java applications 28 and 29, the application management module 32 of the basic functional module 24 changes screen display currently-outputting module information (i.e., information indicating which module is currently producing and outputting a screen display) (in step ST56). In other words, the application management module 32 of the basic functional module 24 changes the screen display currently-outputting module information from information indicating the navigation service 25 of the basic functional module 24 to information indicating the JavaVM 30 of the extended functional module 27.

In the case where the application management module 34 itself is carrying out output of a screen display, the application management module 34 of the extended functional module 27 performs the screen display output processing on the OS 2 only when receiving a notification of acceptance of the request for switching of the source of the on-screen display to either of the Java applications 28 and 29 from the application management module 32 of the basic functional module 24. On the contrary, when the navigation service 25 of the basic functional module 24 desires to output a screen display while the JavaVM 30 of the extended functional module 27 is carrying out output of a screen display, the application management module 32 of the basic functional module 24 can switch to the output of a screen display from the navigation service 25 in the same way as mentioned above.

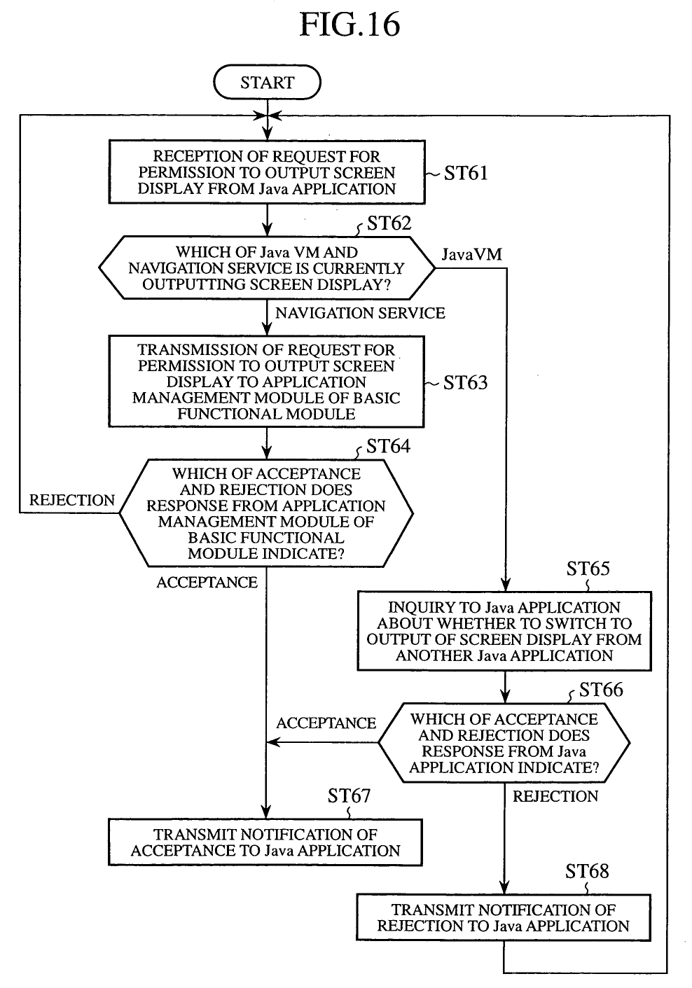

Next, the process of managing output of a screen display performed by the application management module 34 located in the extended functional module 27 will be explained. FIG. 16 is a flow chart showing the process of managing output of a screen display performed by the application management module 34. Switching of the source of a screen display currently being produced between the extended functional module 27 and the basic functional module 24 is carried out as mentioned above. Therefore, the description is directed to the process of managing output of a screen display from either one of the two Java applications 28 and 29 which are running simultaneously, the managing process being performed by the application management module 34 of the extended functional module 27.

Assuming that when one of the plurality of Java applications 28 and 29 which are simultaneously running, e.g. the Java application 28 desires to produce and output a screen display, the Java application 28 makes a request of the application management module 34 for permission to produce and output a screen display (in step ST61). When the JavaVM 30 is not producing and outputting any screen display, that is, when the navigation service 25 of the basic functional module 24 is producing and outputting a screen display (in step ST62), the application management module 34 of the extended functional module 27 transmits a request for permission to produce and output a screen display to the application management module 32 of the basic functional module 24, as mentioned above, in order to make it possible for the extended functional module 27 to produce and output a screen display (in step ST63). When then receiving a notification of acceptance of the request for switching of the source of the screen display currently being produced to the Java application 28 from the application management module 32 of the basic functional module 24 (in step ST64), the application management module 34 of the extended functional module 27 sends a notification of acceptance of the request for permission to produce and output a screen display to the Java application 28 which had made the request for permission to produce and output a screen display (in step ST67).

When the JavaVM 30 is currently producing and outputting a screen display (in step ST62), the application management module 34 of the extended functional module 27 refers to screen display outputting Java application information (i.e., information (which is managed based on the name of the Java application) indicating which Java application is currently producing and outputting a screen display), and specifies the Java application which is currently producing and outputting the on-screen display. For the sake of simplicity, assume that the Java application 29 is currently producing and outputting the on-screen display. The application management module 34 of the extended functional module 27 inquires of the Java application 29, which is currently producing and outputting the on-screen display, whether it can switch to a screen display output from another Java application (in step ST65).

When receiving a response indicating permission to switch to a screen display output from another Java application from the Java application 29 which is currently producing and outputting the on-screen display (in step ST66), the application management module 34 of the extended functional module 27 sends a notification of permission to produce and output a screen display to the Java application 28 which has made the request for permission to produce and output a screen display (in step ST67). On the other hand, when receiving a response indicating that switching of the source of a screen display currently being output to another Java application is prohibited from the Java application 29 which is currently producing and outputting the on-screen display (in step ST66), the application management module 34 of the extended functional module 27 sends a notification of rejection of output of a screen display to the Java application 28 which has made the request for permission to produce and output a screen display (in step ST68).

As previously explained, when switching the source of the screen display currently being output between two Java applications, the application management module 34 of the extended functional module 27 inquires of the Java application, which is currently producing and outputting the on-screen display, whether the Java application permits switching of the source of the on-screen display to another Java application which has made a request for permission to produce and output a screen display. As an alternative, the application management module 34 of the extended functional module 27 can forcedly switch to a screen display output from another Java application which has made a request for permission to produce and output a screen display without inquiring of the Java application 29, which is currently producing and outputting the on-screen display, whether the Java application permits switching of the source of the on-screen display to the other Java application. As an alternative, the application management module 34 of the extended functional module 27 can assign priorities to the plurality of Java applications and additionally write the priorities to the application management table in advance. In this variant, the application management module 34 gives a higher priority to a request for permission to produce and output a screen display from a Java application with a higher priority.

As can be seen from the above description, in accordance with this embodiment 1, when the plurality of Java applications 28 and 29 which can run simultaneously on the extended functional module 27 are installed into the extended functional module 27, the application management modules 32 and 34 manage the operations of the plurality of Java applications 28 and 29. Therefore, the present embodiment offers an advantage of being able to cause the plurality of Java applications 28 and 29 to operate simultaneously without causing a resource conflict in the information providing system. Thus, the plurality of Java applications 28 and 29 can be made to start up and stop in cooperation with each other, and therefore the extended vehicle-mounted information service rises in value. For example, the information providing system in accordance with this embodiment can easily start up an advertisement program for displaying an advertisement such as a dealer service before starting a game.

In addition, in accordance with this embodiment 1, since the application management modules 32 and 34 carry out the process of adding a Java application to the extended functional module 27, the process of deleting a Java application from the extended functional module 27, and the process of updating a Java application already installed into the extended functional module 27, the information providing system can incorporate a plurality of Java applications thereinto while preventing any Java application from being overlappedly installed thereinto, thereby avoiding the use of an additional resource (e.g., a certain amount of RAM space and/or a certain amount of disk space).

Furthermore, in accordance with this embodiment 1, when receiving a request for permission to produce and output a screen display from either the navigation service 25 of the basic functional module 24 or the Java application 28 or 29, the application management modules 32 and 34 gives permission to produce and output a screen display to either the navigation service 25 or the Java application 28 or 29 of the basic functional module 24 according to the screen display output request. Therefore, the present embodiment offers an advantage of being able to output a screen display from a desired one of the plurality of Java applications when the plurality of Java applications 28 and 29 desire to output their screen displays, respectively.

In addition, in accordance with this embodiment 1, the application management modules 32 and 34 manage the operations of the plurality of Java applications 28 and 29 according to input information given by the user. Therefore, the present embodiment offers another advantage of being able to allow the user to input information to a desired Java application even when the plurality of Java applications 28 and 29 are running simultaneously.

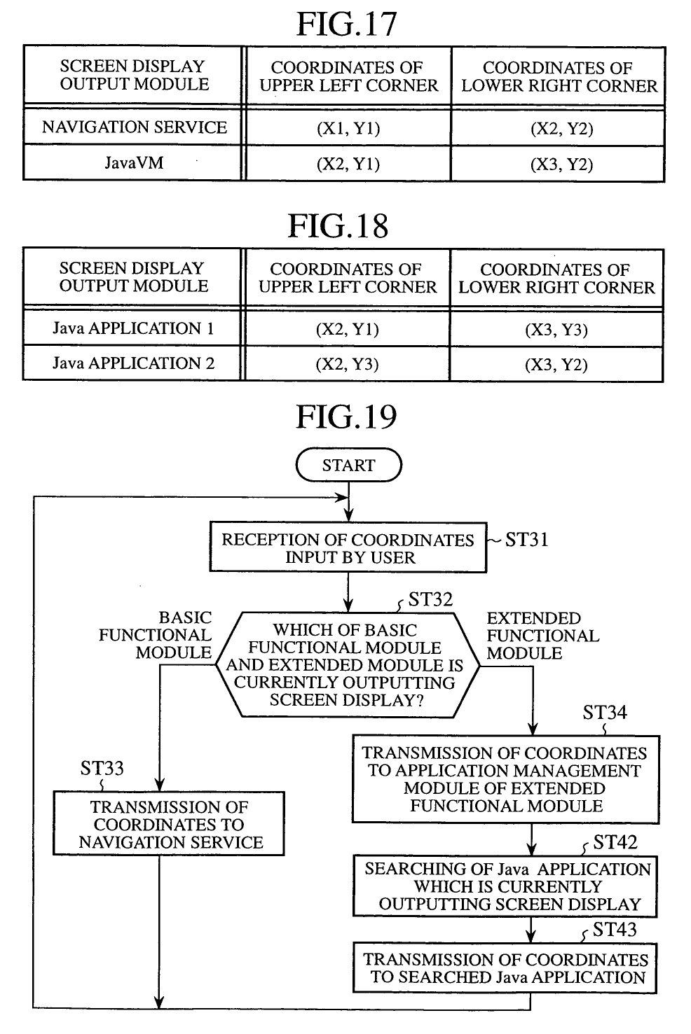

In accordance with this embodiment 1, either the basic functional module 24 or the extended functional module 27 can produce a single screen display, as previously mentioned. As an alternative, the basic functional module 24 and the extended functional module 27 can produce a split screen display (see FIG. 13). In this case, the application management module 34 of the extended functional module 27 only has to make a request for splitting of the screen and perform switching of the source of the on-screen display between the basic functional module 24 and the extended functional module 27 according to permission or rejection in the same way that the above-mentioned switching processing is carried out (the navigation service 25 can produce a split screen display). When the coordinates of both the upper left corner and the lower right corner are managed as viewing areas in the split screen, as shown in FIG. 17, it is possible to determine whether the touched position of the touch panel is related to an input to which module in the above-mentioned input management processing.

As previously mentioned, the JavaVM 30 of the extended functional module 27 can also produce a split screen display (see FIG. 14). Since a process of producing a split screen display which is performed by the JavaVM 30 of the extended functional module 27 is the same as the above-mentioned process performed by the basic functional module 24, the explanation of the split screen display process performed by the JavaVM 30 will be omitted. Each Java application can manage screen display output Java application information as shown in FIG. 18 in order to determine whether the touched position of the touch panel is related to an input to which Java application.

Embodiment 2.

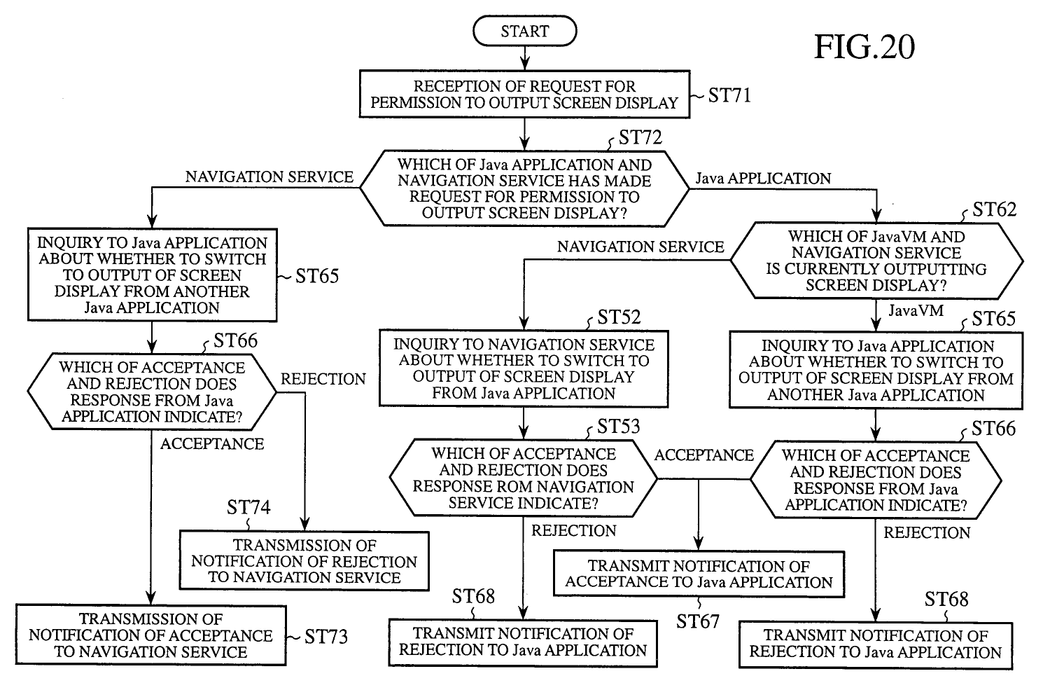

In above-mentioned embodiment 1, it is assumed that each of both the basic module side and the extended module side has an input management function (3) and a screen display output management function (4). In contrast, in accordance with embodiment 2 of the present invention, a basic functional module 24 has all functions. This means that Java applications 28 and 29 which run on an extended functional module 27 are managed by an application management module 32 of the basic functional module 24, like a navigation service 25 (see FIGS. 19 and 20). In FIG. 20, step ST71 shows a reception process of receiving a request for permission to produce and output a screen display which is made by the application management module 32 of the basic functional module 24, and step ST72 shows a process of determining which Java application has made the request for permission to produce and output a screen display which is performed by the application management module 32. Step ST73 shows a permission notification process of providing a notification of acceptance of a request for permission to produce and output a screen display to the navigation service 25, and step ST74 shows a rejection notification process of providing a notification of rejection a request for permission to produce and output a screen display to the navigation service 25. On the contrary, only the extended functional module 27 can perform all of the input management function (3) and the screen display output management function (4). This means that the navigation service 25 is managed by the application management module 34 of the extended functional module 27, like the Java applications 28 and 29 (that is, the navigation service 25 is handled in the same way that the Java applications are handled).

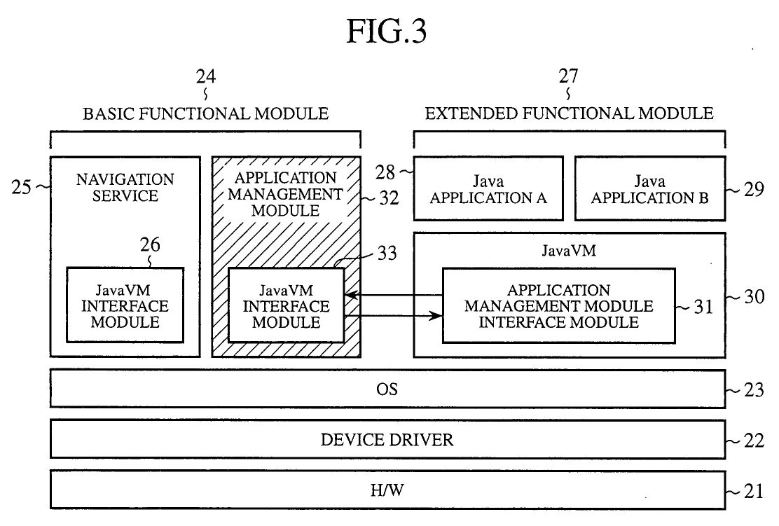

Furthermore, the application management module 32 of the basic functional module 24 can manage all processes, such as a registration process (1) and a startup process (2) (in this case, what is necessary is just to dispose an I/F required for addition, deletion, startup, stop and status management of a Java application for each interface module). In this case, the application management module 32 of the basic functional module 24 performs all application management processes, and the information providing system has a software configuration as shown in FIG. 3, for example. As a result, since the basic functional module 24 which runs with a higher priority manages the Java applications 28 and 29 when the basic functional module 24 is made to operate with a higher priority than the extended functional module 27, the information providing system can start up and stop the Java applications 28 and 29 more quickly.

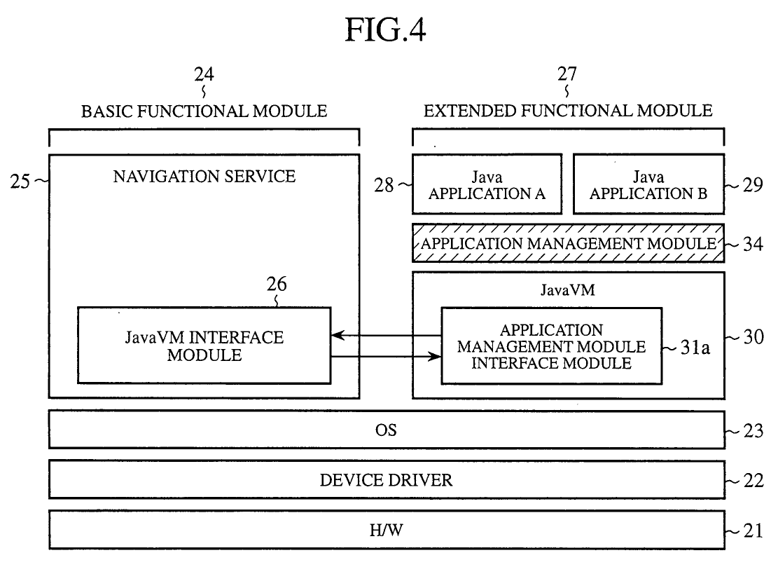

On the contrary, the application management module 34 of the extended functional module 27 can manage all processings and so on. In this case, the application management module 34 of the extended functional module 27 performs all application management processings, and the information providing system has a software configuration as shown in FIG. 4, for example. As a result, since the application management module 34 of the extended functional module 27 manages the Java applications 28 and 29, communications between the basic functional module 24 and the extended functional module 27 can be eliminated.

Embodiment 3.

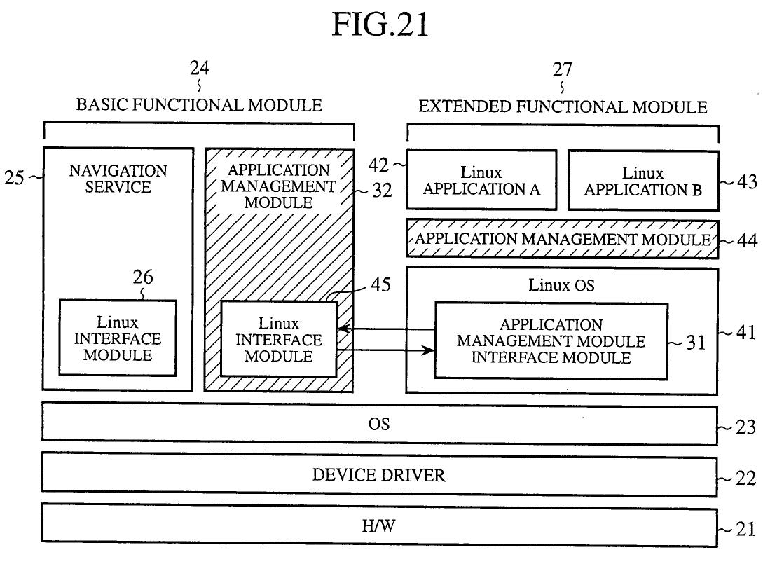

In accordance with above-mentioned embodiment 1, the extended functional module 27 consist of the JavaVM 30 which starts up the Java applications 28 and 29, as previously mentioned. The present invention is not limited to this configuration. For example, as shown in FIG. 21, a Linux OS 41 can be disposed on an OS 23, and can be made to operate as a process. The Linux OS 41 can provide the same functions as the JavaVM 30. In this case, Linux applications 42 and 43 are equivalent to service applications, and an application management module 44 manages the operations of the Linux applications 42 and. 43. A Linux I/F module 45 communicates with an application management module interface module 31.

Embodiment 4.

In accordance with above-mentioned embodiment 1, the user operation unit 7 is a device, such as a touch panel or a joystick, as previously mentioned. In contrast, in accordance with embodiment 4 of the present invention, an information providing system includes a user operation unit 7 provided with a microphone, and a user operation I/F unit 8 provided with a voice recognition engine for converting a user's voice inputted thereto via the microphone into a voice command. The information providing system in accordance with this embodiment has a hardware configuration that is the same as that of above-mentioned embodiment 1 except the microphone.

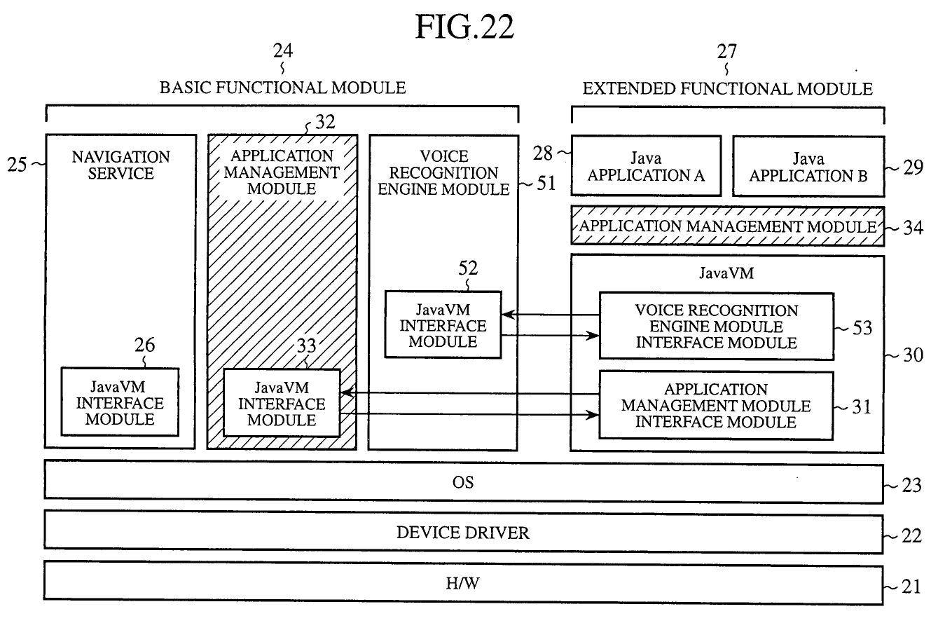

FIG. 22 is a block diagram showing the software configuration of the information providing system in accordance with embodiment 4 of the present invention. In the figure, the same reference numerals as shown in FIG. 2 denote the same components as those of the information providing system in accordance with embodiment 1 or like components, and therefore the explanation of those components will be omitted hereafter. A voice recognition engine module 51 operates as a basic functional module, and recognizes the user's voice. A JavaVM I/F module 52 carries out communications with a voice recognition engine module interface module 53 disposed within a JavaVM 30 when the voice recognition engine module 51 works hand-in-hand with a Java application 28 or 29.

Next, the operation of the information providing system in accordance with this embodiment of the present invention will be explained. The voice recognition engine module 51 of this embodiment 4 can add and delete a command to and from a list of voice recognition commands registered in an initial state. Since the voice recognition engine module 51 can perform the same processing as a voice recognition engine disposed in a prior art car navigation system, the explanation of the operation of the voice recognition engine module 51 will be omitted hereafter. Since the process of adding and deleting a command is the same as a process of adding and deleting a registration point command when the navigation service 25 registers or deletes a registration point into or from a database in a prior art car navigation system, the explanation of the operation of the process of adding and deleting a command will be omitted hereafter. Hereafter, a description will be made as to the two following processes of controlling the voice recognition engine: a process (1) of adding a Java application startup command at the time of addition of a Java application; and a process (2) of adding a voice recognition command which is used within a Java application at the time of startup of the Java application.

(1) The Process of Adding a Java Application Startup Command

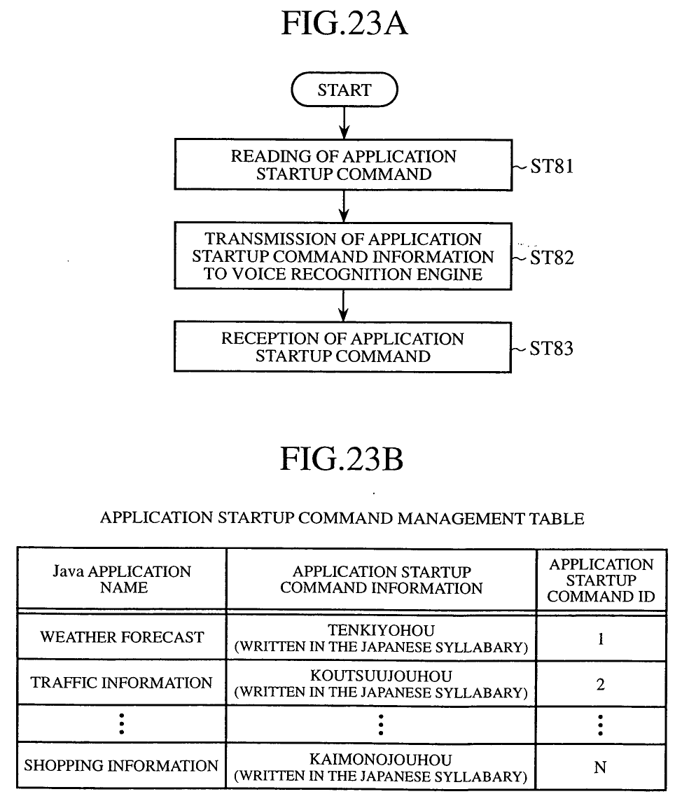

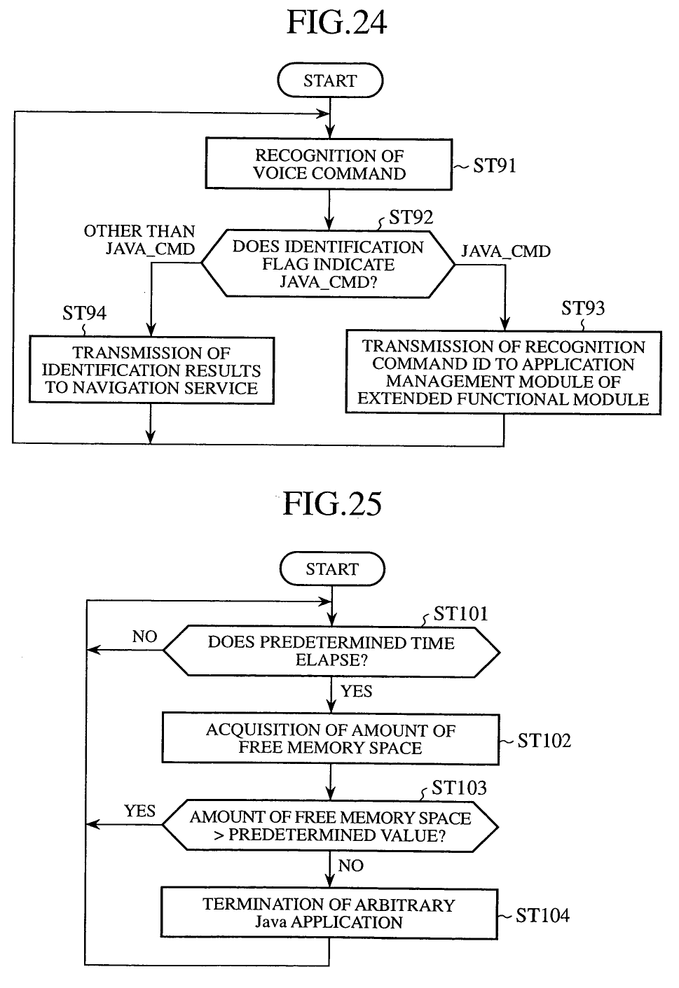

FIG. 23A is a flow chart showing the process of adding a Java application startup command, and FIG. 24 is a flow chart showing a process of recognizing a command. When reading a Java application (in step ST2 of FIG. 5) to perform a process of adding the Java application, as explained in above-mentioned embodiment 1, an application management module 34 of an extended functional module 27 simultaneously reads, as additional information about the Java application to be read, application startup command information (for example, information in which a Japanese (phonetic) syllabary, such as “TENKIYOHOU” (see FIG. 23B), is written when the Java application to be read is an application that performs a weather forecast) (in step ST81). The application management module 34 of the extended functional module 27 then transmits both the application startup command information which is read when expanding the Java application into a RAM 10, and an application startup command ID (i.e., information indicating which line of an application management table specifies the Java application) to the voice recognition engine module 51 of the basic functional module 24 via the voice recognition engine module interface module 53 and the JavaVM I/F module 52 (in step ST82).

When receiving both the application startup command information and the application startup command ID from the application management module 34 (in step ST83), the voice recognition engine module 51 registers the application startup command, the application startup command ID, and an identification flag (for example, a character string like JAVA_CMD) indicating that the application startup command is a command for starting up the Java application into a voice recognition database. When the voice command which the user has issued toward the microphone is a registered command (in steps ST91 and ST92), the voice recognition engine module 51 transmits an corresponding application startup command ID and the identification flag to the application management module 34 of the extended functional module 27 by way of the interface module (in step ST93). When the input voice command is not any command registered by the application management module 34 of the extended functional module, the voice recognition engine module 51 transmits the recognition result to the navigation service 25 (in step ST94). The application management module 34 of the extended functional module 27 starts up the Java application associated with the received application startup command ID according to the same procedure as explained in above-mentioned embodiment 1, after determining that the identification flag indicates that the application startup command is a command for starting up the Java application.

When a Java application is deleted, the application management module 34 of the extended functional module 27 transmits a request for deletion of a corresponding application startup command and a corresponding application startup ID to the voice recognition engine module 51 to the voice recognition engine module 51 by way of the interface module, and the voice recognition engine module 51 deletes the startup command from the voice recognition database.

(2) The Process of Adding a Voice Recognition Command

When sending information indicating permission to produce and output a screen display to a Java application for performing a process of managing the screen display output by the Java application, as explained in above-mentioned embodiment 1, the application management module 34 of the extended functional module 27 carries out a process of reading application voice command information which the Java application holds (e.g., a character string indicating a local name, such as “OOSAKA” or “HYOUGOKEN-NAMBU” or a date, such as “KYOU (i.e., today)” or “ASHITA (i.e., tomorrow”, if the Java application is the one for performing a weather forecast), and application voice command IDs (i.e., IDs each for pointing to a voice command character string).

The application management module 34 of the extended functional module 27 transmits the read application voice command information, the read application voice command IDs each for identifying a corresponding application voice command, and an identification flag (e.g., a character string such as JAVA_APL_CMD) indicating that the commands to be registered are application voice commands to the voice recognition engine module 51 by way of the interface module. When receiving the application voice command information, the application voice command IDs, and the identification flag from the application management module 34 of the extended functional module 27, the voice recognition engine module 51 registers these pieces of information into a voice recognition database.

When recognizing a voice command which the user issues toward the microphone as a command registered by the application management module 34 of the extended functional module 27, the voice recognition engine module 51 transmits the identification flag and a corresponding voice command ID to the application management module 34 of the extended functional module 27 by way of the interface module. After determining that the identification flag transmitted from the voice recognition engine module 51 indicates that the input voice command is an application voice command, the application management module 34 of the extended functional module 27 transmits the received voice command ID to the Java application which is currently producing and outputting a screen display. After that, the Java application performs processing according to the received voice command ID. When the Java application stops outputting the on-screen display or another Java application instead produces and outputs a screen display, the application management module 34 of the extended functional module 27 notifies the voice recognition engine module 51 of erasing of all the registered application voice commands, and the voice recognition engine module 51 then erases all the registered application voice commands from the voice recognition database.

Although it is assumed that only a single Java application produces and outputs a screen display in the above explanation, a plurality of Java applications can produce and output screen displays simultaneously.

In this case, the application voice command ID also includes an application ID (which is the same as the above-mentioned application startup command ID) which indicates which line of the application management table includes information about a corresponding Java application. For example, the application voice command ID can be 4-byte data, such as 0x00020001, including a voice command ID part that is 2-byte data, such as 0x0001, and an application ID part that is 2-byte data, such as 0x0002. As a result, the application management module 34 of the extended functional module 27 can determine that the inputted voice command is directed to which one of the plurality of Java applications which are producing and outputting screen displays simultaneously. The application management module 32 of the basic functional module 24 can perform the above-mentioned process of adding startup commands and the above-mentioned process of adding voice recognition commands.

As can be seen from the above description, in accordance with this embodiment 4, the application management module 34 is so constructed as to accept registration of voice input commands which a Java application uses by using the voice recognition engine module 51 for recognizing the user's voice. Therefore, the present embodiment offers an advantage of making it possible for the user to operate a desired Java application only by issuing a voice command.

Embodiment 5.

When a plurality of Java applications 28 and 29 run simultaneously, an information providing system which is running by using a limited amount of memory resource may suffer from exhaustion of memory. In accordance with embodiment 5 of the present invention, an application management module 34 manages a memory resource which the Java applications 28 and 29 use, and, when there is a possibility of exhaustion of memory, performs control processing, such as terminating (or stopping) of an arbitrary Java application. Concretely, the application management module 34 performs the management processing as follows. FIG. 25 is a flow chart showing the process of terminating (or stopping) an arbitrary Java application when exhaustion of the memory resource occurs.

An information providing system in accordance with embodiment 5 of the present invention has the same hardware configuration and the same software configuration as that of above-mentioned embodiment 1. A JavaVM 30 secures a predetermined amount of memory resource when it is started up, and information providing system has a total amount of memory resource which the JavaVM 30 is using as memory usage information. A function called getFreeMemory is provided as an API for acquiring the amount of free space of the memory resource which the JavaVM 30 has secured from the application management module 34 of the extended functional module 27, and the JavaVM 30 returns a value which is obtained by subtracting the total of memory resource which the JavaVM 30 is using from the memory resource secured thereby when it has been started up to the Java application which has called the function.

First, the application management module 34 of the extended functional module 27 calls the above-mentioned function at predetermined intervals (e.g., every one minute) so as to acquire the amount of free space of the memory resource (in steps ST101 and ST102). When acquiring the amount of free space of the memory resource, the application management module 34 of the extended functional module 27 determines whether the amount of free space of the memory resource is equal to or less than a predetermined value (in step ST103), and, when determining that the amount of free space of the memory resource is equal to or less than the predetermined value, avoids the occurrence of exhaustion of memory by terminating an arbitrary Java application according to the same procedure as explained in above-mentioned embodiment 1 (in step ST104).

As can be seen from the above description, in accordance with this embodiment 5, the application management module 34 is so constructed as to manage the operations of the plurality of Java applications 28 and 29 in consideration of a memory resource which the plurality of Java applications 28 and 29 can use. Therefore, the present embodiment offers an advantage of being able to stabilize the operation of the information providing system.

The application management module 34 manages the memory resource which the JavaVM 30 has secured, as previously explained. As an alternative, the application management module 34 can manage a memory resource (i.e., all of DRAM) intended for the whole of the information providing system. In this case, an API for acquiring the amount of free space of the memory resource for the whole of the information providing system is provided on an OS 23, and, when a Java application calls the API of the JavaVM 30, the JavaVM30 acquires the amount of free space of the memory resource for the information providing system by way of the above-mentioned API.

In addition, as previously mentioned, the application management module 34 of the extended functional module 27 terminates (or stops) an arbitrary Java application when needed. As an alternative, the application management module 34 of the extended functional module 27 can memorize the order which it has started up Java applications, and can terminate a Java application which has been most recently started up or started up at the earliest time. Priorities can be assigned to the plurality of Java applications and the Java application with the lower priority will be terminated first, as explained in above-mentioned embodiment 1.

Furthermore, as previously mentioned, when determining that the amount of free space of the memory resource is equal to or less than the predetermined value, the application management module 34 of the extended functional module 27 terminates an arbitrary Java application. In addition, when additional coverage occurs in memory space, the application management module 34 of the extended functional module 27 can restart the Java application which has been forcedly stopped.

The resource of the information providing system that is the target for administration is only the memory resource, as previously explained. As an alternative, the resource of the information providing system can be writing of files into a recording medium such as a hard disk drive. In this variant, when there is not enough free space in the hard disk drive, the application management module 34 of the extended functional module 27 can make a request of a Java application for deletion of files which the Java application is using.

In accordance with this embodiment 5, the application management module 34 of the extended functional module 27 performs the process of stopping an arbitrary Java application when needed, as previously mentioned. As an alternative, the application management module 32 of the basic functional module 24 can acquire the amount of free space of the memory resource by way of the interface module and then perform the process of stopping an arbitrary Java application when determining that the amount of free space of the memory resource is equal to or less than the predetermined value.

Embodiment 6.

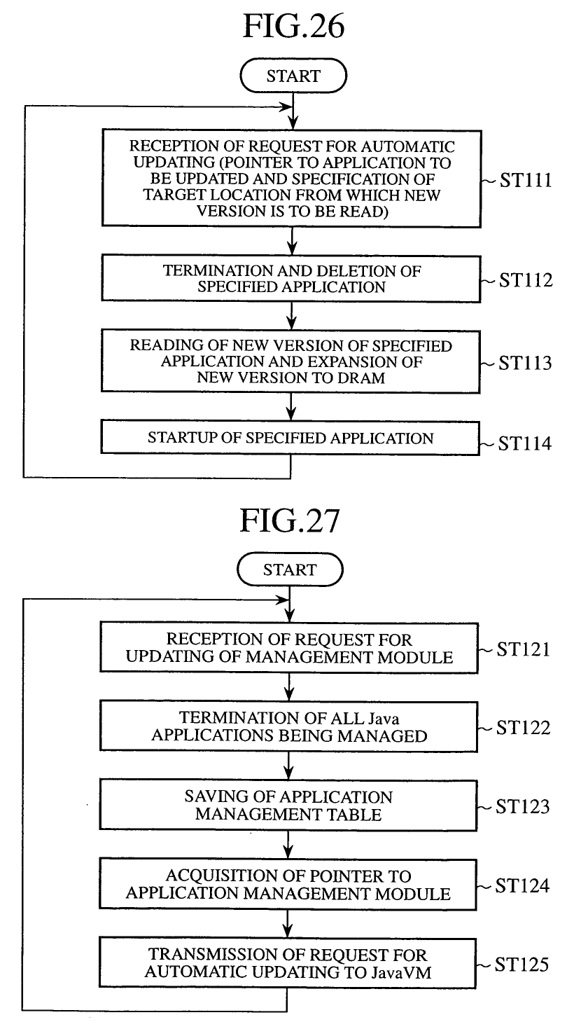

In accordance with above-mentioned embodiment 1, each of the application management modules 32 and 34 can update each Java application by deleting each Java application or adding a new version of each Java application. In contrast, in accordance with embodiment 6, an information providing system can update each application management module itself. Concretely, the information providing system in accordance with this embodiment updates each application management module itself as follows. FIG. 26 is a flow chart showing automatic updating processing performed by a JavaVM, and FIG. 27 is a flow chart showing automatic updating processing performed by an application management module 34.

The information providing system in accordance with this embodiment has the same hardware configuration and the same software configuration as that of above-mentioned embodiment 1. An API for automatic updating is disposed in the JavaVM 30, the API having, as arguments, a pointer (i.e., a DRAM address) specifying a Java application and a target (i.e., a DVD-ROM or the like) from which the API reads a new version of the Java application. When called, this API stops the Java application specified by the pointer thereof while deleting the Java application from the DRAM (in steps ST111 and ST112), and then reads a new version of the Java application from the specified target and then expands the new version of the Java application into the DRAM (in step ST113). After that, the API starts up the expanded Java application (in step ST114).

When receiving a request for updating of the application management module 34 of the extended functional module 27 (in step ST121), the application management module 34 stops all Java applications being managed thereby (in step ST122), and then saves the application management table at a predetermined location (in step ST123). After that, the application management module 34 of the extended functional module 27 acquires its own pointer from the JavaVM 30 by using a “this variable” (in step ST124), and transmits both its own pointer acquired thereby and a predetermined target from which the API reads a new version of the application management module to the JavaVM 30 as the arguments of the above-mentioned API (in step ST125). The JavaVM 30 then updates and automatically starts up the application management module 34 according to the above-mentioned procedure. After started up, the application management module 34 reads the application management table saved at the predetermined location and starts performing the application management processing.

As can be seen from the above description, in accordance with this embodiment 6, the JavaVM 30 of the extended functional module 27 is so constructed as to update the application management module 34 when needed. Therefore, the present embodiment offers an advantage of being able to easily extend the management method of managing Java applications. As previously explained, the API reads a new version of the application management module from the predetermined target. As an alternative, the user can be allowed to specify a location from which the API reads a new version of the application management module. As in the case of above-mentioned embodiment 1, the predetermined target from which the API reads a new version of the application management module is not limited to the external recording medium 2. For example, the API can download a new version of the application management module placed in a network by way of a network connection device connected to the network, such as a mobile phone.

Many widely different embodiments of the present invention may be constructed without departing from the spirit and scope of the present invention. It should be understood that the present invention is not limited to the specific embodiments described in the specification, except as defined in the appended claims.

1. An information providing system comprising:
a basic functional module for providing a fundamental information service;
an extended functional module for, when a service application for providing an extended function which is not provided by said basic functional module is installed thereinto, starting said service application in cooperation with said basic functional module; and
an application management module for managing operations of a plurality of service applications which can run simultaneously on said extended functional module.

2. The information providing system according to claim 1, wherein said system includes said application management module as submodules of said basic functional module.

3. The information providing system according to claim 1, wherein said system includes said application management module as one service application that is installed into said extended functional module.

4. The information providing system according to claim 3, wherein said extended functional module updates said application management module.

5. The information providing system according to claim 1, wherein said system includes one said application management module as submodules of said basic functional module and one said application management module as one service application that is installed into said extended functional module, and both said application management modules manage the operations of the plurality of service applications in cooperation with each other.

6. The information providing system according to any one of claims 1 to 5, wherein said application management module carries out a process of adding a service application to said extended functional module, a process of deleting a service application from the extended functional module, and a process of updating a service application in said extended functional module.

7. The information providing system according to claim 1, wherein in response to a request for permission to output a screen display from said basic functional module or one said service application, said application management module gives permission to output a screen display to either said basic functional module or said service application.

8. The information providing system according to claim 1, wherein said application management module manages the operations of the plurality of service applications according to input information given by a user.

9. The information providing system according to claim 1, wherein said application management module receives registration of voice commands which said service application uses by using a voice recognition engine for recognizing a user's voice.

10. The information providing system according to claim 1, wherein said application management module manages the operations of the plurality of service applications in consideration of available resources.

11. The information providing system according to claim 1, wherein said application management module manages the operations of the plurality of service applications in consideration of priorities assigned to the plurality of service applications.

12. The information providing system according to claim 1, wherein said application management module manages the operations of the plurality of service applications in consideration of both available resources and priorities assigned to the plurality of service applications.
